(19) United States
(12) Patent Application Publication
(10) Pub. No.: US 2006/0234766 A1
(43) Pub. Date: Oct. 19, 2006

(54) Methods and systems for providing wireless information transportation using dual frequencies

(75) Inventors: Michael Gillin, Atlanta, GA (US); Kenneth Williams, Kennesaw, GA (US); Pablo Kelly Piquerez, Kennesaw, GA (US)

Correspondence Address: MERCHANT & GOULD PC, P.O. BOX 2903, MINNEAPOLIS, MN, 55402-0903, US

(73) Assignee: Cox Communications, Inc., Atlanta, GA (US)

(21) Appl. No.: 11/237,108

(22) Filed: Sep. 28, 2005

Related U.S. Application Data
(60) Provisional application No. 60/672,783, filed on Apr. 19, 2005.

(51) Int. Cl. H04M 1/00

(52) U.S. Cl. 455/553.1; 455/552.1

(57) ABSTRACT

Systems and methods are disclosed for providing wireless information transportation. The disclosed systems and methods may include using an unlicensed radio frequency to transmit information from a first point to a second point in a data transport system and determining that the unlicensed radio frequency no longer provides a sufficient service level. Furthermore, the disclosed systems and methods may include discontinuing using the unlicensed radio frequency to transmit information from the first point to the second point in the data transport system when it is determined that the unlicensed radio frequency no longer provides the sufficient service level. Moreover, the disclosed systems and methods may include using a licensed radio frequency to transmit information from the first point to the second point in the data transport system when use of the unlicensed radio frequency is discontinued.

### RELATED APPLICATION

Under provisions of 35 U.S.C. § 119(e), Applicants claim the benefit of U.S. provisional application No. 60/672,783 entitled “METHODS AND SYSTEMS FOR PROVIDING A POINT-TO-POINT WIRELESS HOP USING DUAL FREQUENCIES,” filed Apr. 19, 2005, which is incorporated herein by reference.

### BACKGROUND OF THE INVENTION

I. Field of the Invention

The present invention generally relates to methods and systems for providing wireless information transportation. More particularly, the present invention relates to providing wireless information transportation using dual frequencies.

II. Background Information

Service providers, such as broadband service providers, generally provide service to customer premises using, for example, a wire or fiber. In many situations, however, the service providers' access to customer premises using wires or fibers may be limited. For example, access to the customer may be constrained or even forbidden by the customer's building owner. In addition, many times the prospective revenue associated with a service may not warrant the services construction cost. For example, the prospective revenue may not justify the cost for trenching underneath a parking lot and serving a customer premises. Furthermore, access to customer premises using wires or fibers may be limited due to historic ordinances or right-of-way constraints. For example, construction at the customer premises may be prohibited by law or the location may be so congested that construction to the customer premises may not be possible.

Moreover, in some situations, while the service provider's access to the customer premises using wires or fibers may not be limited, it may be delayed by issues beyond the service provider's control. For example, in some locations, it may take a time period (e.g. 6 months to a year) to be permitted by a local government to construct service to a customer premises using, for example, a wire or fiber. The service provider, however, may have already signed a contract that is ready to generate revenue. In this situation, the construction delay may result in lost revenue for the service provider.

Thus, the conventional strategy is to provide service using, for example, a wire or a fiber. This often causes problems because the conventional strategy does not address the aforementioned access limitations. In view of the foregoing, there is a need for methods and systems for providing wireless information transportation more optimally. Furthermore, there is a need for providing wireless information transportation using dual frequencies.

### SUMMARY OF THE INVENTION

Consistent with embodiments of the present invention, systems and methods are disclosed for providing wireless information transportation.

In accordance with one embodiment, a method for providing wireless information transportation comprises using an unlicensed radio frequency to transmit information from a first point to a second point in a data transport system, determining that the unlicensed radio frequency no longer provides a sufficient service level, discontinuing using the unlicensed radio frequency to transmit information from the first point to the second point in the data transport system when it is determined that the unlicensed radio frequency no longer provides the sufficient service level, and using a licensed radio frequency to transmit information from the first point to the second point in the data transport system when use of the unlicensed radio frequency is discontinued.

According to another embodiment, a system for providing wireless information transportation comprises an unlicensed radio configured to use an unlicensed radio frequency to transmit information from a first point to a second point in a data transport system and an licensed radio configured to use a licensed radio frequency to transmit information from the first point to the second point in the data transport system when use of the unlicensed radio frequency is discontinued when it is determined that the unlicensed radio frequency no longer provides the sufficient service level.

In accordance with yet another embodiment, a computer-readable medium which stores a set of instructions which when executed performs a method for providing wireless information transportation, the method executed by the set of instructions comprising using an unlicensed radio configured to use an unlicensed radio frequency to transmit information from a first point to a second point in a data transport system and using an licensed radio configured to use a licensed radio frequency to transmit information from the first point to the second point in the data transport system when use of the unlicensed radio frequency is discontinued when it is determined that the unlicensed radio frequency no longer provides the sufficient service level.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary wireless transport system consistent with an embodiment of the present invention; and

FIG. 2 is a block diagram of an exemplary dual frequency radio system consistent with an embodiment of the present invention

FIG. 3 is a flow chart of an exemplary method for providing wireless information transportation consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide wireless information transportation. Embodiments of the present invention may comprise a wireless transportation system used, for example, in lieu of wire or fiber line construction. By using a wireless transportation system, for example, unfavorable building access agreements, legal constraints, right-of-way constraints, construction costs, and construction time delays may be avoided.

In providing wireless information transportation, service providers may wish to “guarantee” service, but also may wish to limit the cost for providing the service as much as possible. Consistent with an embodiment of the invention, an unlicensed and a licensed frequency may be used. While there may be no licensing cost for the unlicensed frequency, because the number of unlicensed wireless access points is growing, crowding in the unlicensed frequencies in some locations may present one risk with using unlicensed frequencies. With licensed frequencies, while the user may have exclusive use (unlike unlicensed frequencies), one issue may be that the Federal Communications Commission (FCC) charges a licensing fee, for example, for a 10 year point-to-point license. Accordingly, a cost may be associated with using the licensed frequency that may not be found with the unlicensed frequency.

An embodiment consistent with the invention may comprise a system for providing wireless information transportation. The system may comprise an unlicensed radio configured to use an unlicensed radio frequency to transmit information from a first point to a second point in a data transportation system. Furthermore, the system may comprise a licensed radio configured to use a licensed radio frequency to transmit information from the first point to the second point in the data transportation system when use of the unlicensed radio frequency is discontinued when it is determined that the unlicensed radio frequency no longer provides a sufficient service level. The aforementioned system is exemplary and other systems, components, or processors may comprise the aforementioned system consistent with embodiments of the present invention.

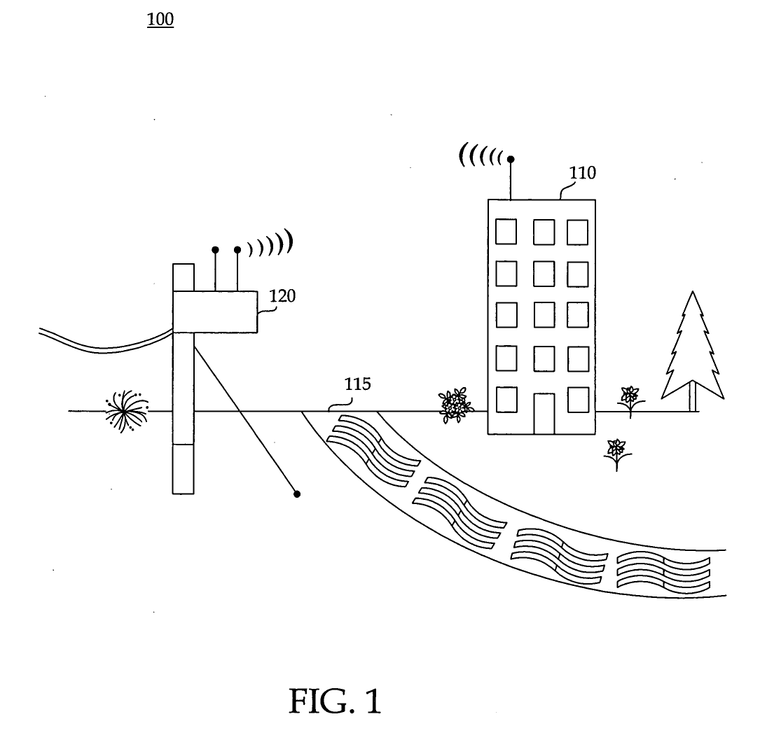

By way of a non-limiting example, FIG. 1 illustrates a wireless transport system 100 in which the features and principles of the present invention may be implemented. As illustrated in the block diagram of FIG. 1, system 100 may include a customer premises 110, an obstacle 115, and a dual frequency radio system 120. A service provider, such as a broadband service provider for example, may wish to provide service to customer premises 110 using, for example, a wire or fiber (not shown). The service provider's access to customer premises 110 using wires or fibers, however, may be limited. For example, obstacle 115 may limit the service provider's access to customer premises 110. While FIG. 1 shows a river as obstacle 115, the river is exemplary, and obstacle 115 may comprise anything that may limit the service provider's access to customer premises 110.

In addition, prospective revenue associated with a service may not warrant the cost, for example, for trenching underneath obstacle 115 (e.g. a parking lot, a river, a road, etc.) to server customer premises 110. Furthermore, obstacle 115 may not be a physical element. For example, access to customer premises 110 may be constrained or even forbidden by the customer's building owner. Furthermore, access to customer premises using wires or fibers may be limited due to historic ordinances or right-of-way constraints. For example, construction at customer premises 110 may be prohibited by law or customer premises 110 may be so congested that construction to customer premises 110's location may not be possible.

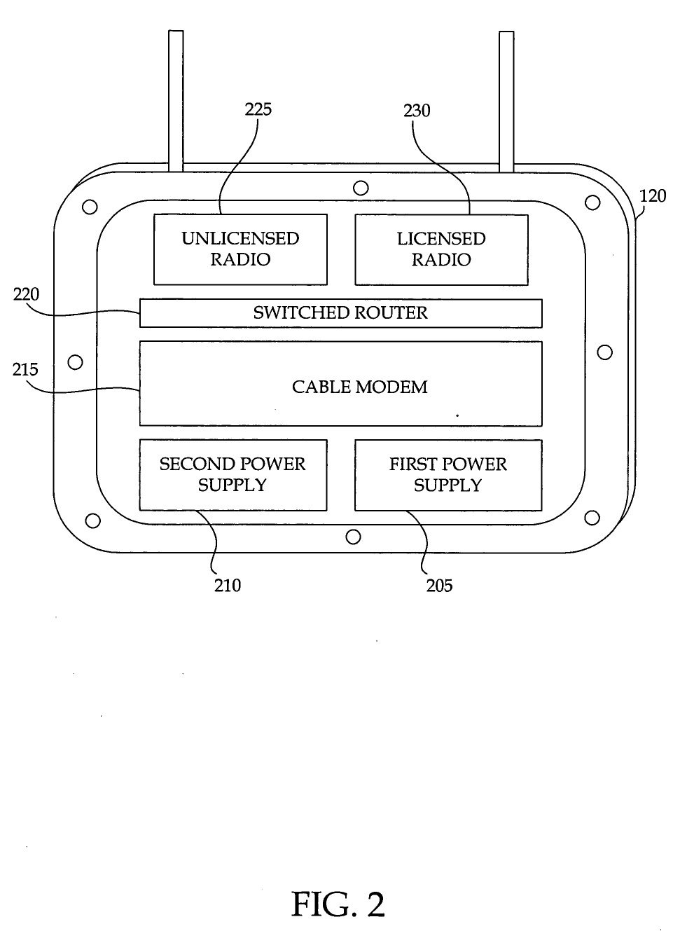

In order to overcome obstacle 115, service may be provided to customer premises 110 wirelessly using, for example, dual frequency radio system 120. FIG. 2 shows dual frequency radio system 120 of FIG. 1 in more detail. As shown in FIG. 2, dual frequency radio system 120 may include a first power supply 205, a second power supply 210, a cable modem 215, a switched router 220, an unlicensed radio 225, and a licensed radio 230. Dual frequency radio system 120 may be powered by first power supply 205, which may be backed-up by second power supply 210. Data may enter dual frequency radio system 120 via cable modem 215. Once the data enters dual frequency radio system 120, switched router 220 may direct the data to either of unlicensed radio 225 and licensed radio 230. Unlicensed radio 225 may operate on an unlicensed frequency band. Likewise, licensed radio 230 may operate on a licensed frequency band. The unlicensed frequency band may comprise, but not limited to, a 900 MHz band, a 2.4 GHz band, and a 5.8 GHz band. The licensed frequency band may comprise, but not limited to, a 700 MHz band, 1.9 GHz band, 2.3 GHz band, 2.5 GHz band, 18 GHz band, and a 24 GHz band. The aforementioned are exemplary and the unlicensed frequency band and the licensed frequency band may comprise other frequencies.

System 100 may initially operate using unlicensed radio 225. If the unlicensed frequency becomes congested or crowded at some date after the initial installation, a license may be purchased from, for example, the FCC and dual frequency radio system 120 may be switched to operate using licensed radio 230. The aforementioned license purchased from the FCC may, for example, comprise a point-to-point license. Accordingly, the license cost may be avoided for a time period or may never need to be realized. Furthermore, the service provider may “guarantee” the service because unlicensed radio 225, if it's frequency band becomes crowded, can be backed-up with licensed radio 230. In this way, the service provider may “guarantee” the service and the cost of a frequency license may be delayed for a time or avoided altogether.

Wireless can be defined as radio transmission via the airwaves. However, it may be appreciated that various other communication techniques can be used to provide wireless transmission, including infrared line of sight, cellular, microwave, satellite, packet radio, and spread spectrum radio. For example, equipment in customer premises 110 and dual frequency radio system 120 may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, a world interoperability for microwave access (WiMAX) interface, an IEEE 802.16 interface, another RF communication interface, and/or an optical interface.

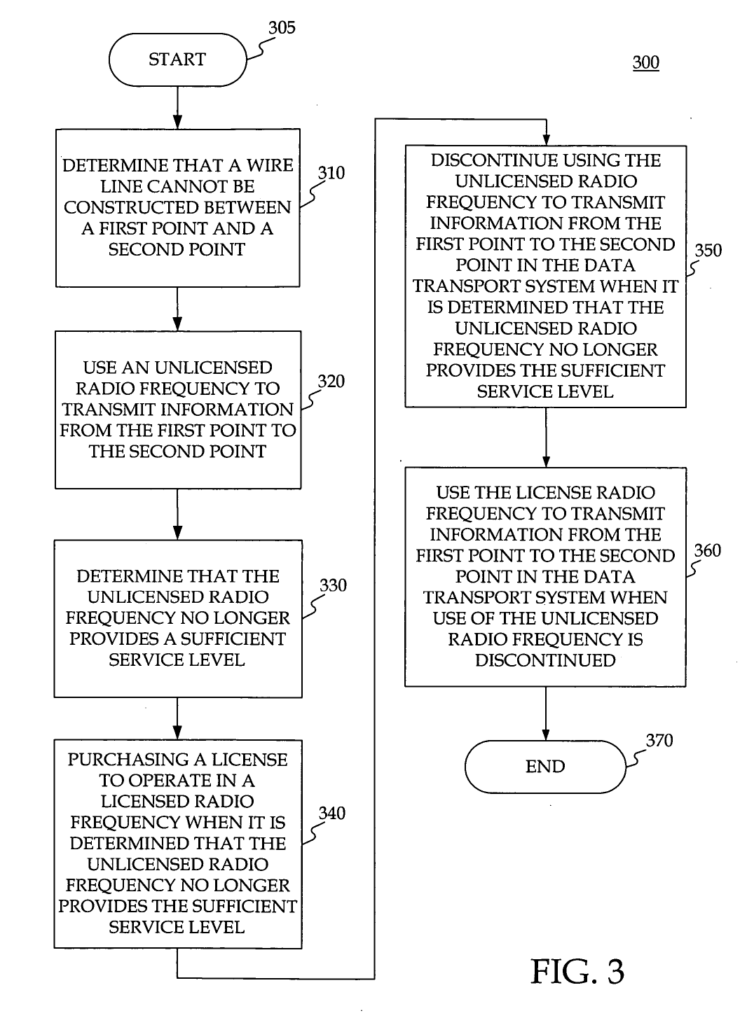

FIG. 3 is a flow chart setting forth the general stages involved in an exemplary method 300 consistent with the invention for providing wireless information transportation using system 100 of FIG. 1. Exemplary ways to implement the stages of exemplary method 300 will be described in greater detail below. Exemplary method 300 may begin at starting block 305 and proceed to stage 310 where a service provider may determine that a wire line cannot be constructed between a first point and a second point. For example, the service provider's access to customer premises 110 using wires or fibers may be limited. Obstacle 115, for example, may limit the service provider's access to customer premises 110. Obstacle 115 may comprise anything that may limit the service providers' access to customer premises 110.

In addition, prospective revenue associated with a service may not warrant the cost, for example, for trenching underneath obstacle 115 (e.g. a parking lot, a river, a road, etc.) and serving customer premises 110. Furthermore, obstacle 115 may not be a physical element. For example, access to customer premises 110 may be constrained or even forbidden by the customer's building owner. Furthermore, access to customer premises using wires or fibers may be limited due to historic ordinances or right-of-way constraints. For example, construction at customer premises 110 may be prohibited by law or customer premises 110 may be so congested that construction to customer premises 110's location may not be possible.

From stage 310, where the service provider may determine that the wire line cannot be constructed, exemplary method 300 may advance to stage 320 where the service provider may provision dual frequency radio system 120 to use an unlicensed radio frequency to transmit information from the first point to the second point. For example, the first point may comprise dual frequency radio system 120 and the second point may comprise customer premises 110. Accordingly, unlicensed radio 225 may transmit information to customer premises 110 on an unlicensed frequency band comprising, but not limited to, one of a 900 MHz band, a 2.4 GHz band, and a 5.8 GHz band. The aforementioned are exemplary and the unlicensed frequency may comprise other bands.

Once the service provider provisions dual frequency radio system 120 in stage 320, exemplary method 300 may continue to stage 330 where the service provider may determine that the unlicensed radio frequency no longer provides a sufficient service level. For example, while there may be no licensing cost with using an unlicensed radio frequency, because the number of wireless access points is growing, crowding in the unlicensed frequencies in some locations may present one risk with using unlicensed frequencies. If the quality of service that the server provider is providing to customer premises 110 degrades to an unacceptable level, the service provider may determine that the unlicensed radio frequency no longer provides a sufficient service level. The threshold between the sufficient service level and the unacceptable level may be defined by a contract between the service provider and the customer or by an industry standard. The quality of service may be based on the band width provided to equipment at customer premises 110 by dual frequency radio system 120, the speed of the connection between equipment at customer premises 110 and dual frequency radio system 120, or the number of lost packets between equipment at customer premises 110 and dual frequency radio system 120. The aforementioned are exemplary, and the quality of service may be based on other indices.

After the service provider determines that the unlicensed radio frequency no longer provides the sufficient service level in stage 330, exemplary method 300 may proceed to stage 340 where the service provider may purchasing a license to operate in a licensed radio frequency. The service provider may purchase the license when it is determined that the unlicensed radio frequency no longer provides the sufficient service level. For example, the license may be purchased from, for example, the FCC and may comprise a point-to-point license. The licensed frequency band may comprise, but not limited to, a 700 MHz band, a 1.9 GHz band, a 2.3 GHz band, a 2.5 GHz band, a 18 GHz band, and a 24 GHz band. The aforementioned are exemplary, and the frequency may be used in ways other than point-to-point and may comprise other bands.

From stage 340, where the service provider purchases the license, exemplary method 300 may advance to stage 350 where the service provider may provision dual frequency radio system 120 to discontinue using the unlicensed radio frequency to transmit information from the first point to the second point in the data transportation system. Using the unlicensed radio frequency may be discontinued when it is determined that the unlicensed radio frequency no longer provides the sufficient service level. For example, after the service provider determines that the unlicensed radio frequency no longer provides the sufficient service level and obtains a frequency license, the service provider may provision dual frequency radio system 120 to discontinue using unlicensed radio 225.

Once the service provider provisions dual frequency radio system 120 to discontinue using the unlicensed radio frequency in stage 350, exemplary method 300 may continue to stage 360 where the service provider may provision dual frequency radio system 120 to use the licensed radio frequency to transmit information from the first point to the second point in the data transportation system. The service provider may provision dual frequency radio system 120 to use the licensed radio frequency when use of the unlicensed radio frequency is discontinued. For example, after the service provider provisions dual frequency radio system 120 to discontinue using unlicensed radio 225, the service provider may provision dual frequency radio system 120 to use licensed radio 230. After the service provider provisions dual frequency radio system 120 to use the licensed radio frequency in stage 360, exemplary method 300 may then end at stage 370.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing wireless information transportation, the method comprising:
using an unlicensed radio frequency to transmit information from a first point to a second point in a data transportation system;
determining that the unlicensed radio frequency no longer provides a sufficient service level;
discontinuing using the unlicensed radio frequency to transmit information from the first point to the second point in the data transportation system when it is determined that the unlicensed radio frequency no longer provides the sufficient service level; and
using a licensed radio frequency to transmit information from the first point to the second point in the data transportation system when use of the unlicensed radio frequency is discontinued.

2. The method of claim 1, further comprising purchasing a license to operate in the licensed radio frequency when it is determined that the unlicensed radio frequency no longer provides the sufficient service level.

3. The method of claim 2, wherein purchasing the license to operate in the licensed radio frequency further comprises purchasing the license limiting the licensed radio frequency's use to a point-to-point configuration.

4. The method of claim 1, further comprising determining that a wire line cannot be constructed between the first point and the second point.

5. The method of claim 1, further comprising determining that a wire line cannot be constructed between the first point and the second point due to at least one of the following: access limited by a building owner; right-of-way to build the wire line cannot be obtained; a historic ordinance prohibits the wire line constriction; and construction costs to construct the wire line are prohibitively expensive.

6. The method of claim 1, wherein using the unlicensed radio frequency further comprises using the licensed radio frequency within one of the following frequency bands: 900 MHz; 2.4 GHz; and 5.8 GHz.

7. The method of claim 1, wherein using the licensed radio frequency further comprises using the licensed radio frequency within one of the following frequency bands: 700 MHz; 1.9 GHz; 2.3 GHz; 2.5 GHz; 18 GHz; and 24 GHz.

8. The method of claim 1, wherein using the unlicensed radio frequency to transmit information further comprises using the unlicensed radio frequency to transmit at least one of voice information and data information.

9. The method of claim 1, wherein using the unlicensed radio frequency to transmit information from the first point to the second point in the data transport system further comprises the data transportation system including a broadband system.

10. The method of claim 1, wherein using the unlicensed radio frequency further comprises using at least one of the following standards: Wireless-Fidelity (Wi-Fi), World Interoperability for Microwave Access (WiMAX), Bluetooth; IEEE 802.16; and IEEE 802.11.

11. The method of claim 1, wherein determining that the unlicensed radio frequency no longer provides the sufficient service level further comprises determining that the unlicensed radio frequency no longer provides at least one of: a level of service defined by a contract between a service provider and a customer and a level of service defined by an industry standard.

12. A system for providing wireless information transportation, the system comprising:
an unlicensed radio configured to use an unlicensed radio frequency to transmit information from a first point to a second point in a data transport system; and
a licensed radio configured to use a licensed radio frequency to transmit information from the first point to the second point in the data transportation system when use of the unlicensed radio frequency is discontinued when it is determined that the unlicensed radio frequency no longer provides a sufficient service level.

13. The system of claim 12, wherein the licensed radio does not have a license to operate until it is determined that the unlicensed radio frequency no longer provides the sufficient service level.

14. The system of claim 12, wherein the licensed radio frequency's use is limited to a point-to-point configuration.

15. The system of claim 12, wherein the unlicensed radio frequency further comprises a frequency within one of the following frequency bands: 900 MHz; 2.4 GHz; and 5.8 GHz.

16. The system of claim 12, wherein the licensed radio frequency further comprises a frequency within one of the following frequency bands: 700 MHz; 1.9 GHz; 2.3 GHz; 2.5 GHz; 18 GHz; and 24 GHz.

17. The system of claim 12, wherein the unlicensed radio is configured to transmit at least one of voice information and data information.

18. The system of claim 12, wherein the data transportation system further comprises a broadband system.

19. The system of claim 12, wherein the unlicensed radio is further configured to use at least one of the following standards: Wireless-Fidelity (Wi-Fi), World Interoperability for Microwave Access (WiMAX), Bluetooth; IEEE 802.16; and IEEE 802.11.

20. A computer-readable medium which stores a set of instructions which when executed performs a method for providing wireless information transportation, the method executed by the set of instructions comprising:
using an unlicensed radio configured to use an unlicensed radio frequency to transmit information from a first point to a second point in a data transport system; and
using a licensed radio configured to use a licensed radio frequency to transmit information from the first point to the second point in the data transport system when use of the unlicensed radio frequency is discontinued when it is determined that the unlicensed radio frequency no longer provides a sufficient service level.
